(19) United States
(12) Patent Application Publication
(10) Pub. No.: US 2014/0149787 A1
(43) Pub. Date: May 29, 2014

(54) METHOD AND SYSTEM FOR COPYBACK COMPLETION WITH A FAILED DRIVE

(71) Applicant: LSI CORPORATION, Milpitas, CA (US)

(72) Inventors: Siddharth Suresh Shanbhag, Bangalore (IN); Manoj Kumar Shetty H, Bangalore (IN); Pavan Gururaj, Bangalore (IN)

(73) Assignee: LSI CORPORATION, Milpitas, CA (US)

(21) Appl. No.: 13/688,368

(22) Filed: Nov. 29, 2012

(51) Int. Cl. G06F 11/20

(52) U.S. Cl. CPC G06F 11/2094
USPC 714/6.11; 714/6.23; 714/6.22

(57) ABSTRACT

Disclosed is a method and system for saving the copybacked data in a drive and continuing to rebuild on the same drive where the copy back was in progress when the online drive, where the copy back is not initiated, fails.

### BACKGROUND OF THE INVENTION

Direct Attached Storage (DAS) refers to a digital storage system directly attached to a server or workstation, without a storage network in between. The term is generally used to differentiate non-networked storage from storage area network (SAN) and Network-attached storage (NAS). Typically, a DAS system is comprised of a data storage device (a collection of hard disk drives in a suitable chassis) connected directly to a computer through a host bus adapter (HBA). Between the computer and the data storage devices there is no network device, such as a hub, switch or router.

### SUMMARY OF THE INVENTION

An embodiment of the invention may therefore comprise a system for continuing a copyback in a system in a storage system, said system comprising a first drive, and a second drive, the second drive initiating a copyback using a third drive, wherein, if the second drive fails during the copyback such that the copyback is aborted, the third drive is enabled to act as a rebuild drive and be rebuilt from the first drive.

An embodiment of the invention may further comprise a method of continuing a copyback in a system with a plurality of drives, the method comprising creating a system comprising at least a first drive and a second drive, initiating a copyback on the second drive to a third drive, and if the second drive fails such that the copyback is aborted, initiating a rebuild on the third drive from the first drive.

### BRIEF DESCRIPTION OF THE DRAWINGS

FIG. 1 shows a copyback operation with two drives.

FIG. 2 shows a system where a drive fails.

FIG. 3 shows a copyback being aborted.

FIG. 4 is a flow diagram of a copyback.

### DETAILED DESCRIPTION OF THE EMBODIMENTS

Embodiments of this invention are methods and systems for a copy back drive acting as a spare and continuing to rebuild when the online drive fails. The copy backed data is saved and the rebuild continues on the same drive where the copy back was in progress when the online drive fails. The online drive is not where the copy back is initiated.

In some scenarios of Direct Attached Storage (DAS), when a drive is replace, i.e. when a copy back is started on a drive and a certain percentage is completed, e.g. 10%, there is a possibility that a failure may occur in the drive on which the copy back was not initiated. The copy back may be aborted and either an emergency, global, or dedicated hot spare may initiate and the rebuild will restart and complete on that drive. If there is not an unconfigured good drive present, then the virtual drive would be in a degraded state and chances increase of the other drive, which is online, going bad with the virtual drive being offline.

In an embodiment of the invention, the drive on which the copy back is being initiated will begin rebuild. This means that the drive itself will act as a hot spare and rebuild will continue from where the copy back had paused, or stalled. This will save the time required to rebuild the entire emergency, global, or dedicated hot spare drive. A hot spare or hot standby is used as a failover mechanism to provide reliability in system configurations. The hot spare is active and connected as part of a working system. When a key component fails, the hot spare is switched into operation. More generally, a hot standby can be used to refer to any device or system that is held in readiness to overcome an otherwise significant start-up delay.

Typically, copyback is a data recovery operation wherein data from one disk in an array is duplicated onto another disk. Copyback is not a backup operation, but instead is used to store information such as data about the physical configuration of the disks in an array. Copyback allows complex arrays to run continuously with minimal downtime.

The copyback feature allows you to copy data from a source drive of a virtual drive to a destination drive that is not a part of the virtual drive. Copyback is often used to create or restore a specific physical configuration for a drive group (for example, a specific arrangement of drive group members on the device I/O buses).

When a drive fails or is expected to fail, the data is rebuilt on a hot spare. The failed drive is replaced with a new disk. Then the data is copied from the hot spare to the new drive, and the hot spare reverts from a rebuild drive to its original hot spare status. The copyback operation runs as a background activity, and the virtual drive is still available online to the host.

A hot spare disk may be a disk or group of disks used to automatically or manually, depending upon the hot spare policy, replace a failing or failed disk in a RAID configuration. The hot spare disk reduces the mean time to recovery (MTTR) for the RAID redundancy group, thus reducing the probability of a second disk failure and the resultant data loss that would occur in any singly redundant RAID (e.g., RAID-1, RAID-5, RAID-10). Typically, a hot spare is available to replace a number of different disks and systems employing a hot spare normally require a redundant group to allow time for the data to be generated onto the spare disk. During this time the system is exposed to data loss due to a subsequent failure, and therefore the automatic switching to a spare disk reduces the time of exposure to that risk compared to manual discovery and implementation.

The concept of hot spares is not limited to hardware, but also software systems can be held in a state of readiness, for example a database server may have a software copy on hot standby, possibly even on the same machine to cope with the various factors that make a database unreliable, such as the impact of disc failure, poorly written queries or database software errors.

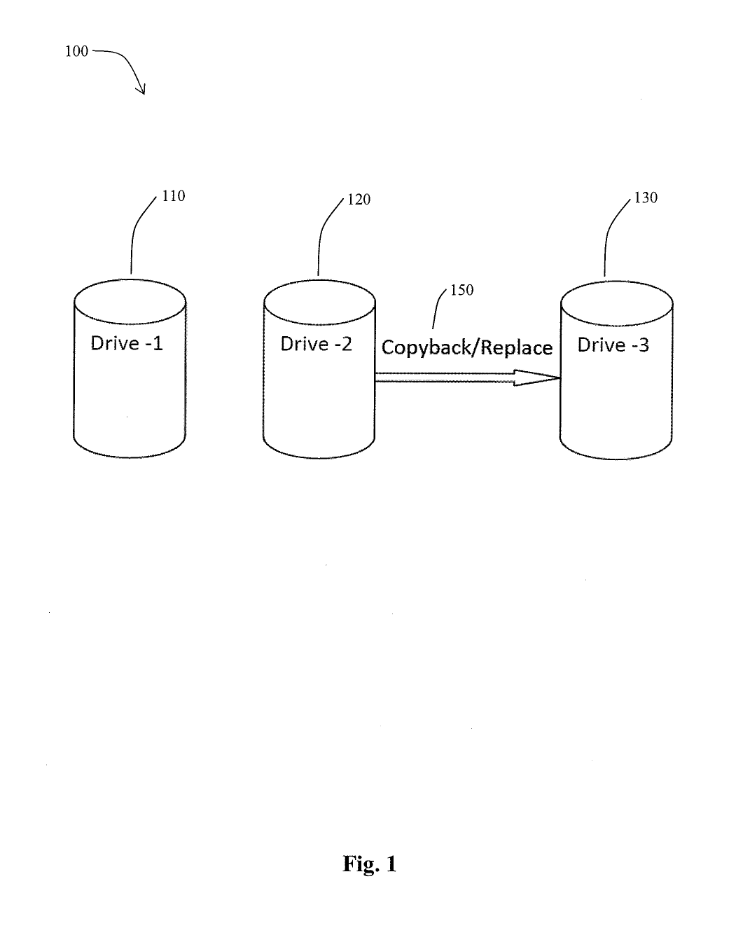

FIG. 1 shows a copyback operation with two drives. The system 100 may be a RAID 1 type system. A drive 1 110 and drive 2 120 are a part of the system. Drive 3 130 in the system 100 is replacing (copyback) 150 drive 2 120. In other words, a copyback is in progress on drive 2 120 to drive 3 130.

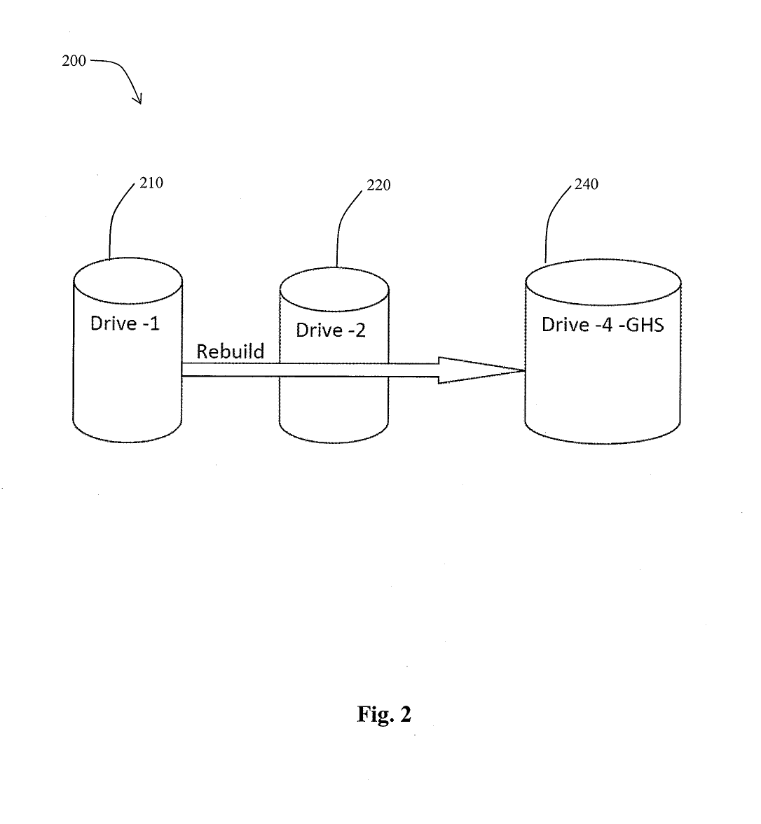

FIG. 2 shows a system where a drive fails. The system 200 may be a RAID 1 type system. In the system, drive 2 120 fails. The failure occurs in drive 2 120, which is a source drive, when copyback is in progress. Drive 4 240 is a global hot spare. The global hot spare 240 kicks in and drive 1 210 acts as the source drive. The global hot spare, drive 4, 240 is the target drive during the rebuild with the failure in drive 2 220.

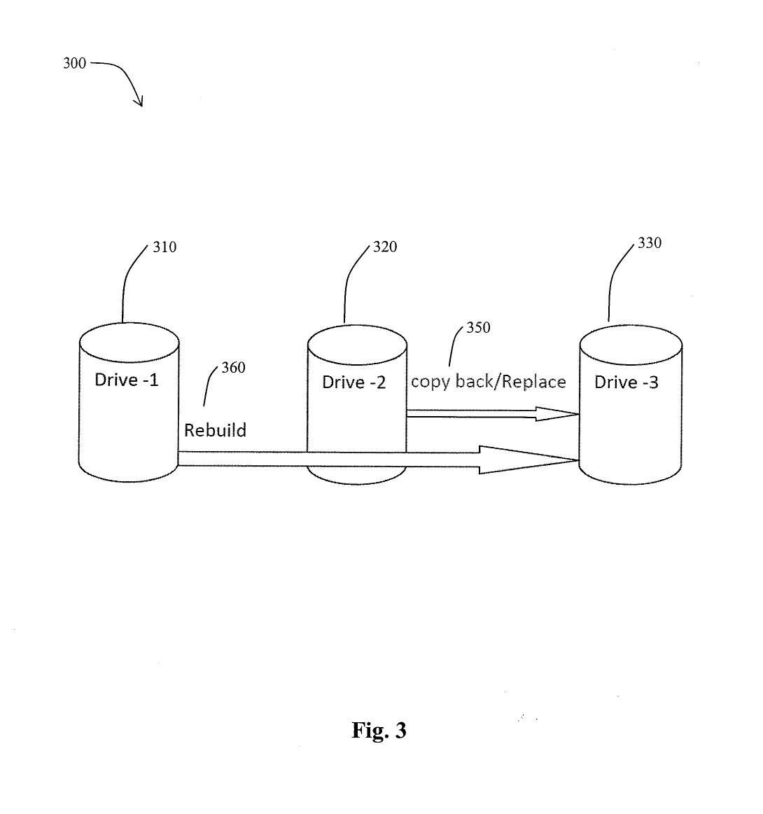

FIG. 3 shows a copyback being aborted. In the system 300, copyback 350 from drive 2 320 to drive 3 330 is aborted. As noted above, this aborted copyback 350 could be due to a failure or other event that cause a termination. In the system 300, the copyback 350 is in progress when drive 2 320 fails. Drive 3 330 responds to the failure of the copyback 350 from drive 2 320 by acting as a hotspare. Drive 1 310 will rebuild 360 drive 3 330 subsequent to the failure of drive 2 320. The rebuild 360 of drive 3 330 may continue from the same place as where the copyback 350 from drive 2 terminated, or discontinued. Drive 3 330, which may be a virtual drive, is not in a degraded mode.

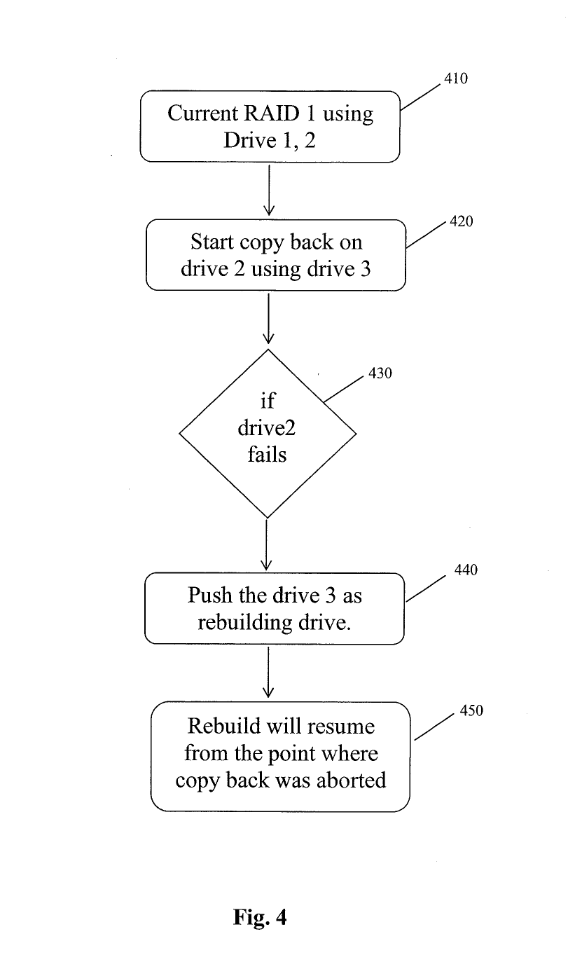

FIG. 4 is a flow diagram of a copyback. A system is initially created 410. The system may be a RAID system or some other similar system utilizing at least a first and second drive. A copyback is initiated on drive 2 420, to drive 3.. The copyback 420 will utilize the third drive. At 430, the drive initiating the copyback fails. Drive 3 will then be initiated as a rebuilding drive 440. Finally, the rebuild of drive 3 will continue 450, utilizing drive 1 as the rebuilding drive. The rebuild of drive 3 may initiate from the point where the copyback was aborted.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system for continuing a copyback in a system in a storage system, said system comprising:
a first drive; and
a second drive, said second drive initiating a copyback using a third drive;
wherein, if the second drive fails during the copyback such that the copyback is aborted, the third drive is enabled to act as a rebuild drive and be rebuilt from the first drive.

2. The system of claim 1, wherein the first drive will rebuild the third drive from a point where the copyback was aborted.

3. The system of claim 1, wherein said system is a RAID 1 system.

4. A method of continuing a copyback in a system with a plurality of drives, said method comprising:
creating a system comprising at least a first drive and a second drive;
initiating a copyback on the second drive to a third drive; and
if the second drive fails such that the copyback is aborted, initiating a rebuild on the third drive from the first drive.

5. The method of claim 4, wherein the rebuild on the third drive will resume from a position where the copyback aborted.

6. The method of claim 4, wherein said system is a RAID system.

7. The method of claim 6, wherein said system is a RAID 1 system.

8. The method of claim 4, wherein:
the rebuild on the third drive will resume from a position where the copyback aborted; and
said system is a RAID system.

9. The method of claim 8, wherein said system is a RAID 1 system.
